(19) United States
(12) Patent Application Publication
(10) Pub. No.: US 2026/0021411 A1
(43) Pub. Date: Jan. 22, 2026

(54) SOFT PAUSE MODE MODIFYING GAME EXECUTION FOR COMMUNICATION INTERRUPTS

(71) Applicant: Sony Interactive Entertainment Inc., Tokyo (JP)

(72) Inventors: Calum Armstrong, San Mateo, CA (US); Anders Lykkehoy, San Mateo, CA (US); Joseph Sommer, San Mateo, CA (US)

(21) Appl. No.: 18/779,787

(22) Filed: Jul. 22, 2024

(51) Int. Cl. A63F 13/67; A63F 13/54; A63F 13/87

(52) U.S. Cl. CPC A63F 13/67; A63F 13/54; A63F 13/87

(57) ABSTRACT

A method for performing a soft pause of a video game is provided, including: executing a video game by a game machine; receiving a trigger event; responsive to the trigger event, then changing the execution of the video game from a normal mode to a soft pause mode of execution, wherein the soft pause mode is configured to continue the execution of the video game with one or more changes to the execution that reduce an intensity of gameplay for a player of the video game.

### BACKGROUND OF THE INVENTION

Modern video games are capable of delivering highly engaging and immersive experiences. However, pausing the game, for example to handle an interruption of some kind, is typically a binary action that completely halts the execution of the video game. Yet such complete pausing of the video game may not be desirable or even possible in some instances. For example, in a multiplayer game setting, complete pause of the game would force all players to stop gameplay, and as such may not be permitted by certain ones of the players.

It is in this context that implementations of the disclosure arise.

### SUMMARY OF THE INVENTION

Implementations of the present disclosure include methods, systems and devices for providing a soft pause mode modifying game execution for communication interrupts.

In some implementations, a method for performing a soft pause of a video game is provided, including: executing a video game by a game machine; receiving a trigger event; responsive to the trigger event, then changing the execution of the video game from a normal mode to a soft pause mode of execution, wherein the soft pause mode is configured to continue the execution of the video game with one or more changes to the execution that reduce an intensity of gameplay for a player of the video game.

In some implementations, the soft pause mode of execution does not stop the gameplay of the video game for the player.

In some implementations, the one or more changes to the execution include reducing an intensity of gameplay sounds generated by the video game.

In some implementations, reducing the intensity of gameplay sounds includes one or more of reducing volume, adjusting frequency equalization, or adjusting spatial audio location of the gameplay sounds.

In some implementations, the one or more changes to the execution include reducing a difficulty setting of the video game.

In some implementations, the one or more changes to the execution include increasing a player assist feature of the video game.

In some implementations, the one or more changes to the execution include slowing time of the video game to reduce a pace of play of the video game for the player.

In some implementations, the trigger event is defined by one or more inputs generated from activation of an input device by the player.

In some implementations, the trigger event is defined by receipt of a message for the player.

In some implementations, the method further includes: responsive to receiving a second trigger event, then ending the soft pause mode and resuming the normal mode of execution of the video game.

In some implementations, method for pausing a video game is provided, including: executing a video game by a game machine; receiving a message for a player of the video game; analyzing the message to determine one or more characteristics of the message; responsive to receiving the message, then changing the execution of the video game from a normal mode to a soft pause mode of execution, wherein the soft pause mode is configured to continue the execution of the video game with one or more changes to the execution that reduce an intensity of gameplay for the player of the video game, wherein the one or more changes are determined based on the characteristics of the message, and, rendering the message to the player during the soft pause mode of execution.

In some implementations, the soft pause mode of execution does not stop the gameplay of the video game for the player.

In some implementations, the one or more changes to the execution include reducing an intensity of gameplay sounds generated by the video game.

In some implementations, reducing the intensity of gameplay sounds includes one or more of reducing volume, adjusting frequency equalization, or adjusting spatial audio location of the gameplay sounds.

In some implementations, the one or more changes to the execution include reducing a difficulty setting of the video game.

In some implementations, the one or more changes to the execution include increasing a player assist feature of the video game.

In some implementations, the one or more changes to the execution include slowing time of the video game to reduce a pace of play of the video game for the player.

In some implementations, the determined characteristics of the message include one or more of a subject of the message, an urgency of the message, or a format of the message.

In some implementations, analyzing the message uses an artificial intelligence model.

Other aspects and advantages of the disclosure will become apparent from the following detailed description, taken in conjunction with the accompanying drawings, illustrating by way of example the principles of the disclosure.

### BRIEF DESCRIPTION OF DRAWINGS

The disclosure may be better understood by reference to the following description taken in conjunction with the accompanying drawings in which:

FIG. 1 illustrates a system for implementing a soft pause of a video game, in accordance with implementations of the disclosure.

FIG. 2 illustrates implementation of a soft pause mode of execution in a game scene of a video game, in accordance with implementations of the disclosure.

FIG. 3 illustrates adjustment of audio as part of implementing a soft pause in a video game, in accordance with implementations of the disclosure.

FIG. 4 illustrates a method for implementing a soft pause of a video game, in accordance with implementations of the disclosure.

FIG. 5 illustrates a method for determining a type of pause to implement based on a received message, in accordance with implementations of the disclosure.

FIG. 6 illustrates components of an example device 600 that can be used to perform aspects of the various embodiments of the present disclosure.

### DETAILED DESCRIPTION OF THE INVENTION

Implementations of the present disclosure include methods, systems, and devices for providing a soft pause mode modifying game execution for communication interrupts.

In conventional video game setups, pausing the video game causes the execution of the video game to stop, such that gameplay completely stops and cannot continue until the paused state is ended and the execution resumes. However, such a hard pause of the video game may not be necessary or desirable under certain circumstances, and may not even be feasible in certain situations. For example, a player may not wish to completely stop the video game, but might prefer to be able to continue the gameplay in some fashion. Or in certain multiplayer games, a given player might not be able to pause the entire multiplayer game, and game events will continue regardless of the player’s participation. Furthermore, a hard pause of the video game can be jarring or disorienting for the player, and make it difficult to re-enter gameplay when unpausing from a completely halted state. These effects can be especially prominent in more immersive contexts such as virtual reality in which the video game is experienced using a head-mounted display.

In view of these issues, implementations of the disclosure introduce the concept of a soft pause, in which the mode of execution of the video game is altered to reduce the intensity of gameplay without completely stopping the execution of the game. In this manner, gameplay during the soft pause continues but in a way that is less demanding on the player, so that the player may give attention to something else, such as an incoming message or personal task, or simply take a break from gaming at full attention. In various implementations, the soft pause mode can be triggered manually or automatically in response to an event. The alterations of the execution of the video game during the soft pause can include changes to the game difficulty, graphics, audio, and other aspects as discussed in further detail below.

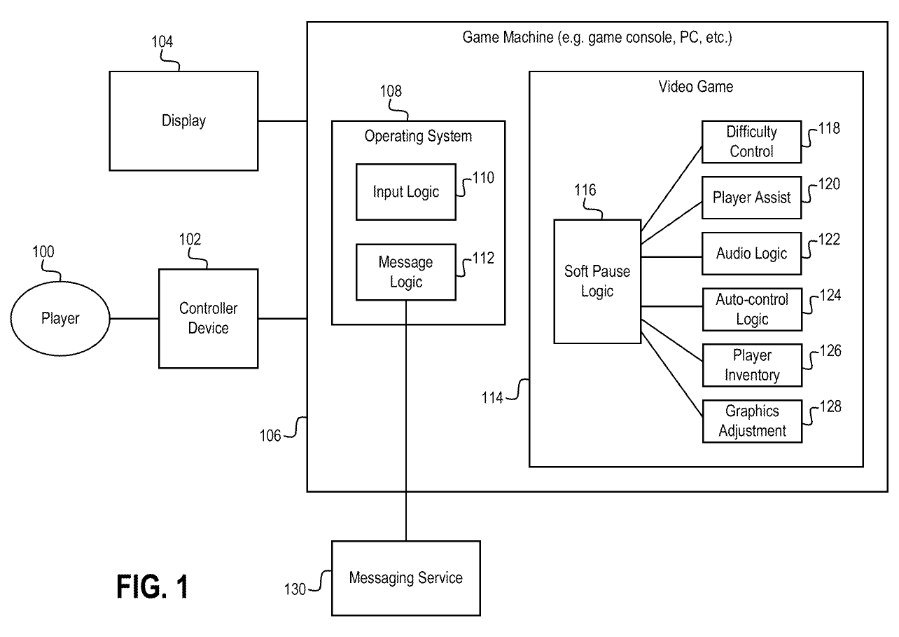

FIG. 1 illustrates a system for implementing a soft pause of a video game, in accordance with implementations of the disclosure.

In the illustrated implementation a video game 114 is executed by a game machine 106. The game machine 106 can be any computing device configured to execute a video game, such as a game console, personal computer, laptop, tablet, mobile device, cellular phone, etc. In cloud gaming implementations, the game machine 106 is situated remotely from the player/user 100, and gameplay is streamed over the Internet.

The player 100 operates or interfaces with a controller device 102 to provide input to the video game 114. And gameplay video generated by the executing video game is output and presented on a display 104, such as a television, monitor, head-mounted display, etc. Also, gameplay audio is generated by the executing video game and presented through speakers, headphones, or other audio devices which can be separate from or integrated with the display 104 in some implementations.

In order to provide a soft pause mode of operation, the video game 114 includes soft pause logic 116, which can be triggered to initiate a soft pause through various mechanisms. In some implementations, the soft pause is triggered manually. For example, the player 100 might trigger a soft pause by pressing a button on the controller device 102. More specifically, the operating system 108 of the game machine 106 can include input logic 110 that manages communication with the controller device 102 and receives signals from the controller device 102 generated from the button press, and accordingly provides input to the video game 114 indicating the button press, which is interpreted by the video game to trigger the soft pause logic 116 to initiate a soft pause of the video game.

It will be appreciated that in providing a soft pause option in combination with the option to perform a hard pause, various input configurations can be specified. For example, in some implementations, a single button press will trigger a soft pause whereas a double-tap of the button will trigger a hard pause; or a single button press will trigger a hard pause whereas a double-tap of the button will trigger a soft pause. In another implementation, a single button press will trigger a soft pause whereas a press-and-hold of the button will trigger a hard pause; or a single button press will trigger a hard pause whereas a press-and-hold of the button will trigger a soft pause. In some implementations, the button can be pressure sensitive, and a light press of the button will trigger a soft pause, where as a hard press of the button will trigger a hard pause. In some implementations, a specific combination of button presses will trigger a soft pause.

It will be appreciated that these examples of triggering a soft pause through a controller device are provided by way of example without limitation, and that in other implementations other specific triggering events can be specified to trigger a soft pause of the video game. For example, in some implementations, a voice command detected through a microphone can be configured to trigger a soft pause. Or in another implementation, a specific gesture or detected motion of the user, for example, detected using a camera or other motion detection hardware, can be configured to trigger a soft pause.

In some implementations, an attention state of the user is detected, for example through analysis of a camera feed of the user and through analysis of the user’s inputs. And based on the detected attention state of the user, then a soft pause may be automatically triggered by the system. For example, if it is determined that the user is distracted or otherwise not fully paying attention to the video game, then the soft pause mode can be automatically triggered. In some implementations, a trained artificial intelligence (AI) or machine learning (ML) model can be used to determine the attention state of the user.

In some implementations, a soft pause can be triggered in response to an incoming message for the player 100. For example, the game machine 106 may receive a message or notification (e.g. over a network such as the Internet) from a messaging service 130. In some implementations, the messaging service 130 is a gaming platform messaging service enabling communications between players on the gaming platform. In other implementations, the messaging service 130 can be a 3^{rd} party messaging service that integrates with the gaming platform, such as a social network messaging service, a chat communication service, etc. The game machine 106 includes message logic 112 (which can be defined as part of the operating system 108) to handle incoming messages and surface them for the player 100, such as by displaying/overlaying them in the video output by the game machine 106, or playing them in the audio output. When a message is received by the message logic 112, it may trigger the soft pause logic 116 to initiate a soft pause of the video game so that the message can be better appreciated by the player 100.

Broadly speaking, a soft pause of the video game 106 is implemented by altering the execution of the video game so as to reduce the intensity of gameplay, so that less attention is required on the part of the player 100, but without completely stopping gameplay or halting the execution of the video game. It will be appreciated that the nature of what specifically constitutes a soft pause for a any given video game can depend on the specific context of that video game. Accordingly, in some implementations, the soft pause logic 116 is implemented by the video game 114 and configured to be triggered to perform the adjustments to game execution that effect the soft pause mode.

For example, in some implementations, the soft pause logic 116 may initiate a soft pause by adjusting a difficulty control 118 of the video game 118 to reduce the level/setting of difficulty of the video game. It will be appreciated that reducing difficulty can affect various aspects of gameplay depending on the video game, such as reducing activity of enemies (e.g. reducing movements, attacks, weapons firing, speed, aggressiveness, etc.), reducing number of enemies spawned, reducing requirements to defeat an enemy, increasing the availability/prevalence resources, etc.

In some implementations, the soft pause logic 116 can perform a soft pause, at least in part, by adjusting a player assist feature 120. For example, the soft pause logic 116 may turn on or increase the effect of a player assist feature such as an auto-aiming or auto-direction feature. For example, in a vehicle racing game, this can include turning on or increasing the effect of an auto-steer assistance feature.

In some implementations, the soft pause logic 116 can perform a soft pause, at least in part, by adjusting audio logic 112 to alter the audio generated by the video game. In some implementations, this can include reducing or turning off certain sounds, such as background music/noise, sounds from specific objects, etc.

In some implementations, the soft pause logic 116 can perform a soft pause, at least in part, by activating auto-control logic 124 to at least partially provide automatic control of the player’s avatar. In this manner, the player’s avatar may act similarly to a non-player character that is automatically controlled by the video game. In some implementations, a trained AI/ML model can be employed to automatically control the player’s avatar. In some implementations, such an AI/ML model can be trained on the player’s own gameplay so as to mimic the gameplay style and tendencies of the player.

In some implementations, the soft pause logic 116 can perform a soft pause, at least in part, by adjusting a player inventory 126. For example, this can include increasing the player avatar’s health/energy/resource, shields/armor, increasing ammunition, etc.

In some implementations, the soft pause logic 116 can perform a soft pause, at least in part, by implementing a graphics adjustment 128, such as by reducing the amount of objects being rendered (e.g. especially objects which are non-essential for gameplay), or desaturating colors of objects, etc.

In further implementations, other techniques can be applied to implement a soft pause of the video game. For example, the soft pause logic 116 can be configured to slow the time of the video game’s execution, so that the pace of the gameplay is slowed, affording the player a slowed gameplay experience while still enabling gameplay to progress.

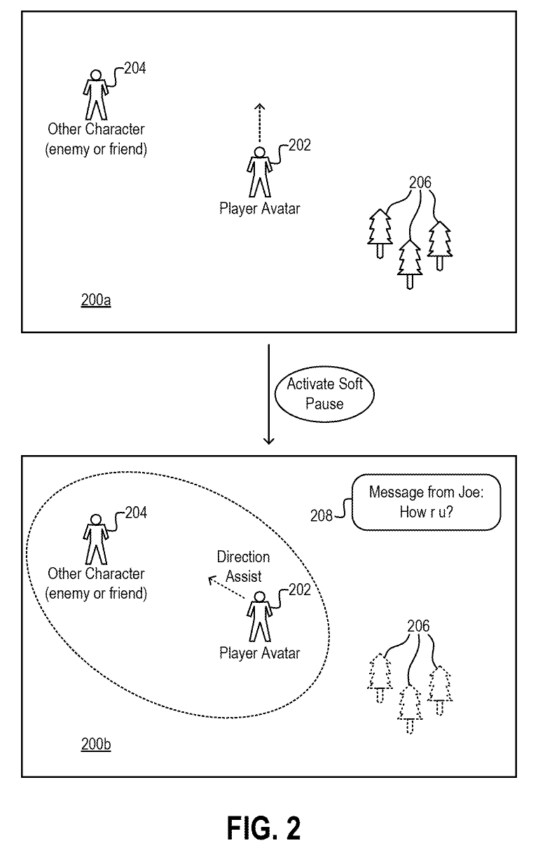

FIG. 2 illustrates implementation of a soft pause mode of execution in a game scene of a video game, in accordance with implementations of the disclosure.

In some implementations, a game scene 200a is shown operating in a normal mode of execution. A player avatar 202 is controlled by the player/user during the gameplay of the video game. Another character 204 (such as an enemy or a friend character) is present, along with objects 206, which can be trees as shown or other objects of the video game present in the scene.

When a soft pause of the video game is initiated, then the video game transitions to a different mode of execution shown by the scene 200b. For instance, a player assistance feature may auto-direct the player avatar 202 towards the other character 204. In the case of the character 204 being an enemy, this may effect auto-aiming of a weapon towards the character 204. Or in the case of the character 204 being a friend, this may facilitate the player following the character 204 during the soft pause.

In some implementations, the soft pause can include adjusting the rendering of the video game to highlight the important aspects and/or deemphasize the less important aspects. For example, in the illustrated implementation a region including the player avatar 202 and the character 204 may be maintained with full color saturation, while other regions of the scene are desaturated, including for example, desaturating the trees 206. In a similar manner, audio from the region including the player avatar 202 and character 204 may be maintained, while audio from other regions is reduced or eliminated.

In some implementations, the soft pause mode is triggered in response to receiving a message/notification for the player of the video game. Thus, during the soft pause, the message 208 can be rendered in the scene, and the user can give attention to the message 208 while the gameplay is at a reduced level of intensity, without completely halting the game’s execution.

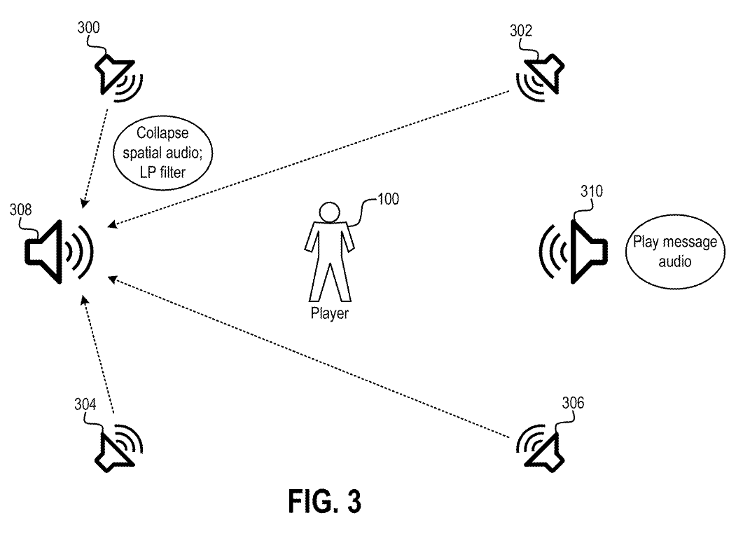

FIG. 3 illustrates adjustment of audio as part of implementing a soft pause in a video game, in accordance with implementations of the disclosure.

In the illustrated implementation, the player 100 is shown, and under normal execution of the video game, spatial audio is generated by the video game to provide an immersive audio experience. For example, the spatial audio can include audio 300, 302, 304, and 306, which as conceptually shown, are configured to surround the player 100 when output through speakers. However, during a soft pause, the audio can be collapsed down to a single audio 308 from a single direction to reduce the gameplay intensity and immersion.

Further, the audio may undergo audio equalization to adjust the relative output of various frequencies. For example, this may entail applying low-pass filtering so that the resulting audio 308 will sound more muted to the player 100. Furthermore, the audio 308 may be configured to be played through one side or otherwise positioned so as to come from a single direction.

While the audio 308 is configured to be played on one side of the player 100, then message audio 310 of an incoming message can be played on the other side. In this manner, the message audio is separated from the gameplay audio to help the player 100 to more clearly hear the message audio.

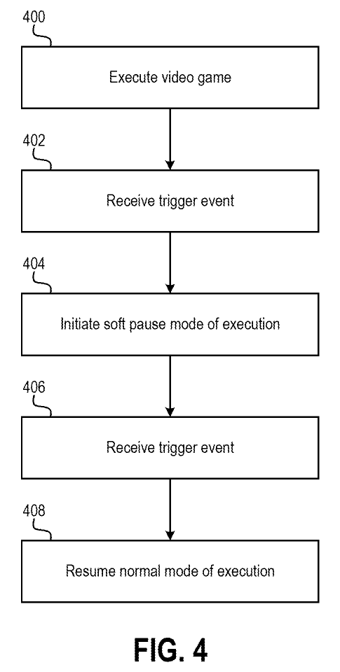

FIG. 4 illustrates a method for implementing a soft pause of a video game, in accordance with implementations of the disclosure.

At method operation 400, a video game is executed. During the execution of the video game, at method operation 402, a trigger event is received, such as receipt of a specific input or receipt of a message/notification, or detecting the player is distracted or not fully attentive, etc. At method operation 404, then in response to the trigger event, a soft pause mode of execution of the video game is initiated, which as described herein, reduces the intensity of the video game for the player.

At method operation 406, a second trigger event is received, such as receipt of a particular input, or completion of a timer, or detecting the user is fully attentive, etc. At method operation 408, then in response to this second trigger event, the normal mode of execution of the video game is resumed.

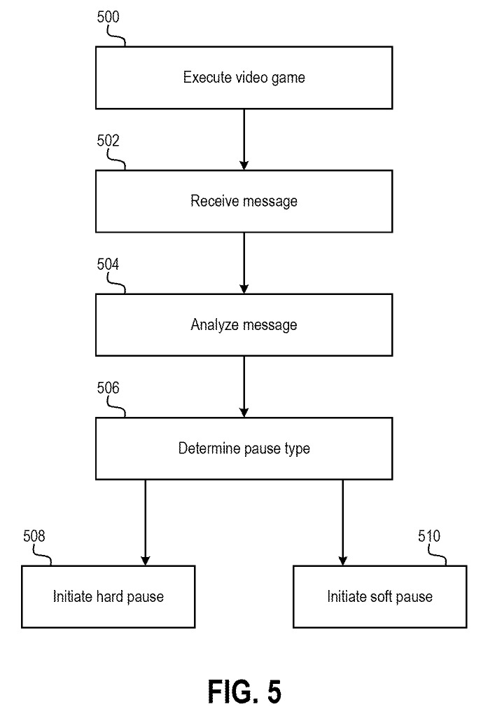

FIG. 5 illustrates a method for determining a type of pause to implement based on a received message, in accordance with implementations of the disclosure.

At method operation 500, a video game is executed by a game machine in a normal mode of execution. At method operation 502, a message for the player of the video game is received.

At method operation 504, the message is analyzed to determine the content, semantic meaning, and/or characteristics of the message. In some implementations, an AI/ML model is used to analyze the message. In some implementations, the analysis of the message can be configured to determine the urgency of the message.

Then at method operation 506, based on the analysis of the message, then a specific pause type is determined to be implemented, and either a hard pause is initiated at method operation 508, or a soft pause is initiated at method operation 510, based on the content or characteristics of the message. For example, a more urgent message may result in a hard pause being initiated, whereas a less urgent message may result in a soft pause being initiated.

In some implementations, the degree or intensity of pausing is variable, ranging from a low degree of soft pause to a higher degree of soft pause to a complete hard pause. It will be appreciated that such a degree of pause can be continuously variable of variable in discreet steps. For example, any of the various changes presently described for effecting a soft pause, such as visual, audio, and gameplay-related changes, can be variably implemented depending upon the degree of the pause that is to be achieved. And different types of changes can be layered upon one another as the degree of pausing increases. For example, a low level soft pause might include certain visual or gamplay-related changes, while a higher level soft pause might further include audio changes, etc. By providing variable amounts of soft pause effects, there is provided a continuum of pausing the game, and the extent of pause that is effected can be responsively triggered by a given event or manually triggered through user input.

For example, as discussed above, the urgency of an incoming message can be determined from its content, and the degree of pause effected can be proportional to the determined urgency of the incoming message. Or the degree of pause can be proportional to a given user input.

In some implementations, the variable degree of pausing can be used to encourage ending gameplay at or before a given time, for example, as a personal setting or a form a parental control. If one wishes to cease gameplay by 9:30pm, for example, then the system could be configured to automatically implement a pause with gradually increasing intensity between 9pm and 9:30pm. This may encourage a user to shut off themselves once gameplay starts to slow or become less immersive, rather than waiting for a hard pause to occur at 9:30pm.

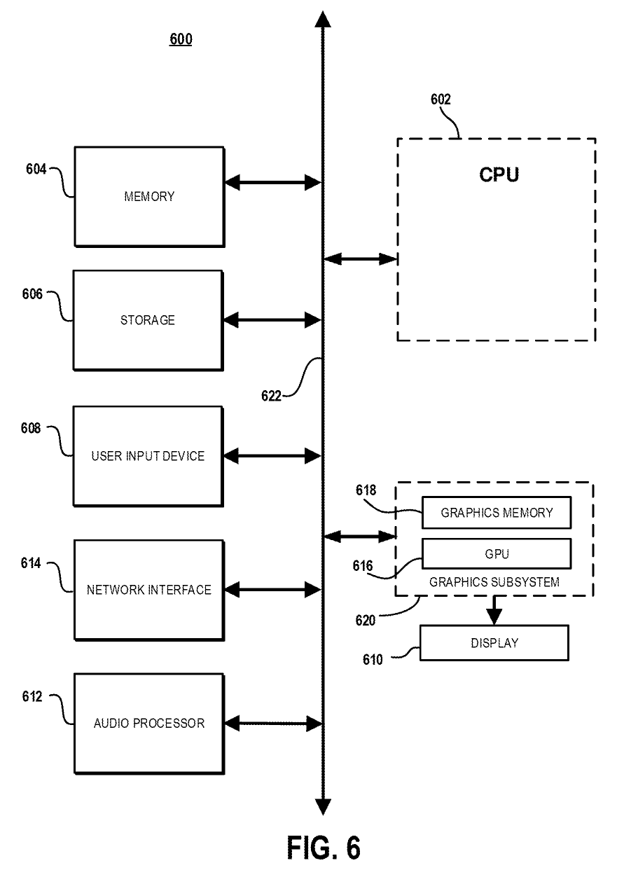

FIG. 6 illustrates components of an example device 600 that can be used to perform aspects of the various embodiments of the present disclosure. This block diagram illustrates a device 600 that can incorporate or can be a personal computer, video game console, personal digital assistant, a server or other digital device, suitable for practicing an embodiment of the disclosure. Device 600 includes a central processing unit (CPU) 602 for running software applications and optionally an operating system. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be a localized to a player playing a game segment (e.g., game console), or remote from the player (e.g., back-end server processor), or one of many servers using virtualization in a game cloud system for remote streaming of gameplay to clients.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 608, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from graphics memory 618 to be displayed on display device 610. Display device 610 can be any device capable of displaying visual information in response to a signal from the device 600, including CRT, LCD, plasma, and OLED displays. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the "cloud" that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user’s available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user’s eyes. Thus, the HMD can provide display regions to each of the user’s eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user’s interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method for performing a soft pause of a video game, comprising:
executing a video game by a game machine;
receiving a trigger event;
responsive to the trigger event, then changing the execution of the video game from a normal mode to a soft pause mode of execution, wherein the soft pause mode is configured to continue the execution of the video game with one or more changes to the execution that reduce an intensity of gameplay for a player of the video game.

2. The method of claim 1, wherein the soft pause mode of execution does not stop the gameplay of the video game for the player.

3. The method of claim 1, wherein the one or more changes to the execution include reducing an intensity of gameplay sounds generated by the video game.

4. The method of claim 3, wherein reducing the intensity of gameplay sounds includes one or more of reducing volume, adjusting frequency equalization, or adjusting spatial audio location of the gameplay sounds.

5. The method of claim 1, wherein the one or more changes to the execution include reducing a difficulty setting of the video game.

6. The method of claim 1, wherein the one or more changes to the execution include increasing a player assist feature of the video game.

7. The method of claim 1, wherein the one or more changes to the execution include slowing time of the video game to reduce a pace of play of the video game for the player.

8. The method of claim 1, wherein the trigger event is defined by one or more inputs generated from activation of an input device by the player.

9. The method of claim 1, wherein the trigger event is defined by receipt of a message for the player.

10. The method of claim 1, further comprising: responsive to receiving a second trigger event, then ending the soft pause mode and resuming the normal mode of execution of the video game.

11. A method for pausing a video game, comprising:
executing a video game by a game machine;
receiving a message for a player of the video game;
analyzing the message to determine one or more characteristics of the message;
responsive to receiving the message, then changing the execution of the video game from a normal mode to a soft pause mode of execution, wherein the soft pause mode is configured to continue the execution of the video game with one or more changes to the execution that reduce an intensity of gameplay for the player of the video game, wherein the one or more changes are determined based on the characteristics of the message, and,
rendering the message to the player during the soft pause mode of execution.

12. The method of claim 11, wherein the soft pause mode of execution does not stop the gameplay of the video game for the player.

13. The method of claim 11, wherein the one or more changes to the execution include reducing an intensity of gameplay sounds generated by the video game.

14. The method of claim 13, wherein reducing the intensity of gameplay sounds includes one or more of reducing volume, adjusting frequency equalization, or adjusting spatial audio location of the gameplay sounds.

15. The method of claim 11, wherein the one or more changes to the execution include reducing a difficulty setting of the video game.

16. The method of claim 11, wherein the one or more changes to the execution include increasing a player assist feature of the video game.

17. The method of claim 11, wherein the one or more changes to the execution include slowing time of the video game to reduce a pace of play of the video game for the player.

18. The method of claim 11, wherein the determined characteristics of the message include one or more of a subject of the message, an urgency of the message, or a format of the message.

19. The method of claim 11, wherein analyzing the message uses an artificial intelligence model.
